(19) United States
(12) Patent Application Publication
(10) Pub. No.: US 2008/0005178 A1
(43) Pub. Date: Jan. 3, 2008

(54) Terminal, a System, and a Method for Managing Resources Needed to Display a Web Page

(75) Inventor: Etienne Annic, Rambouillet (FR)

Correspondence Address: YOUNG & THOMPSON, 745 SOUTH 23RD STREET, 2ND FLOOR, ARLINGTON, VA, 22202, US

(73) Assignee: ORANGEFRANCE, Montrougue (FR)

(21) Appl. No.: 11/791,484

(22) PCT Filed: Dec. 5, 2005
(86) PCT No.: PCT/FR05/03033

§ 371 Date: Jun. 7, 2007

(30) Foreign Application Priority Data
Dec. 6, 2004 (FR) 0412960

(51) Int. Cl. G06F 17/30

(52) U.S. Cl. 707/104.1; 707/E17.001

(57) ABSTRACT

A terminal for managing resources necessary for displaying at least one Web page composed of at least one multimedia object and a declaration document containing at least one declaration element of the or each multimedia object. The declaration document and the or each multimedia object are to be downloaded onto the terminal from an item of storage equipment via a communications network. The terminal comprises a Web browser for interpreting at least one declaration element of at least one resources necessary for displaying the or each multimedia object, said declaration element of the or each multimedia resource being adapted so that it is contained in the declaration document, and said Web browser is capable of transmitting, to the resource manager, a request for allocating the or each resource necessary for displaying the or each multimedia object. Also described is a system and method as well as a structure of a Web page.

The invention relates to a terminal for managing resources needed to display a HyperText Markup Language (HTML) web page.

The invention relates in particular to a terminal for managing resources needed to display at least one web page that consists of at least one multimedia object and a declaration document that includes at least one element that declares the or each multimedia object, the declaration document and the or each multimedia document being downloaded to the terminal from a storage unit via a communications network, and said terminal including a resource manager, a display device, and a web browser.

The invention also relates to a web page structure, to a storage unit, and to a system and a method for managing resources needed to display a web page.

A user of a terminal can access and download web pages from the terminal.

However, web pages consisting of multimedia objects combining text, sound, pictures, etc. are not always displayed on the user's terminal under the conditions intended by their publisher. For example, a video clip can be downloaded without sound or without pictures or can run jerkily or too slowly or not at all.

It is necessary to be able to guarantee a terminal user complete and accurate display of downloaded web pages as intended by their publishers, especially when downloading web pages that have to be paid for, for which the content distributor has an obligation to customers purchasing such pages with regard to the result.

An object of the invention is to propose a terminal that prevents degraded downloading of web pages without the foreknowledge of the terminal user.

To this end, the invention provides a terminal of the above type characterized in that said web browser can interpret at least one element that declares at least one resource needed to render the or each multimedia object, the element that declares the or each resource can be included in the declaration document, and said web browser can send the resource manager a request to allocate the or each resource needed to render the or each multimedia object.

The terminal of the invention advantageously enables the user to accept or refuse the display of a web page that cannot be downloaded under good conditions.

Particular embodiments of the terminal have one or more of the following features:

the resource manager can inform the web browser of the availability of the or each resource and the web browser can send a warning message to the display device if the resource or resources needed to render the or each multimedia object is or are not available and send a request to download the or each multimedia object if the resource or resources is or are available;

it includes an interface for communication between the web browser and said resource manager;

the communication interface is either a proprietary interface or a software interface written in the W3C (World Wide Web Consortium) DOM (Document Object Model) language.

The invention also provides a web page structure that consists of at least one multimedia object and a declaration document that includes at least one element that declares the or each multimedia object, said web page being stored in a storage unit and be downloaded to a terminal via a communications network, which web page structure is characterized in that the declaration document contains at least one element that declares at least one resource needed to render the or each multimedia object.

Particular embodiments of the web page structure have one or more of the following features:

the declaration document includes a body and the or each element that declares the or each resource is included in said body of the declaration document and applies either to a single multimedia object or to all the multimedia objects of the web page;

the declaration document includes a header and the or each element that declares the or each resource is included in that header and applies to all the multimedia objects of the web page;

the declaration document includes a root and the or each element that declares the or each resource is included in that root and applies to all the multimedia objects of the web page;

the or each element that declares the or each resource includes at least one parameter that characterizes resources of the network selected from the group comprising a bandwidth, a delay, a jitter, a loss rate, or a priority and/or at least one parameter that characterizes resources of the terminal selected from the group comprising an available capacity of a microprocessor, an available capacity of a memory, and characteristics of a display device. There is a tolerance for each parameter. The web browser can propose display in a degraded mode commensurate with the indicated tolerance.

The invention further provides a method of managing resources needed to display at least one web page that consists of at least one multimedia object and a declaration document that includes at least one element that declares the or each multimedia object, said web page being downloaded from a storage unit to a terminal via a communications network, the terminal including a resource manager, a web browser and a display device, and said method comprising the following steps:

downloading the declaration document from the storage unit to the terminal, said declaration document including at least one element that declares at least one resource needed to render the or each multimedia object;

the web browser interpreting the or each element that declares the or each resource and sending the resource manager a request to allocate the or each resource needed to render the or each multimedia object;

the resource manager requesting allocation of the available resource or resources of the network and/or the terminal and/or the storage unit;

the web browser sending a warning message to the display device if the resource or resources needed to render the or each multimedia object is or are not available; and

the web browser initiating downloading of the or each multimedia object if the resource or resources needed to render the or each multimedia object is or are available.

The invention further provides a system for managing resources needed to display at least one web page that consists of at least one multimedia object and a declaration document that includes at least one element that declares the or each multimedia object, said system comprising a unit for storing the or each web page, a communications network, and a terminal adapted to download the or each web page from the storage unit via the telecommunications network, which system is characterized in that it includes a terminal.

The invention can be better understood after reading the following description, which is given by way of example only and with reference to the appended drawings, in which:

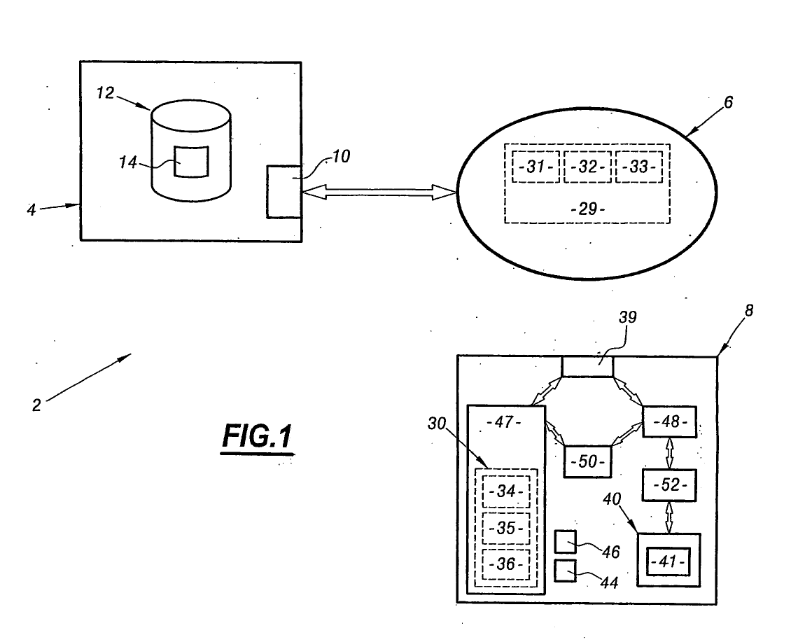

FIG. 1 is a diagram of the architecture of a resource management system according to the invention;

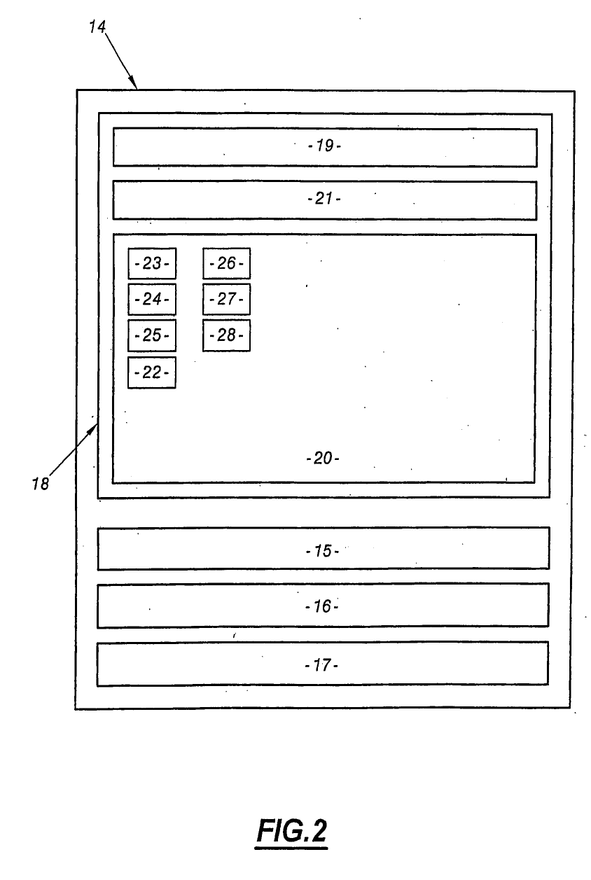

FIG. 2 is a diagram of a web page according to the invention; and

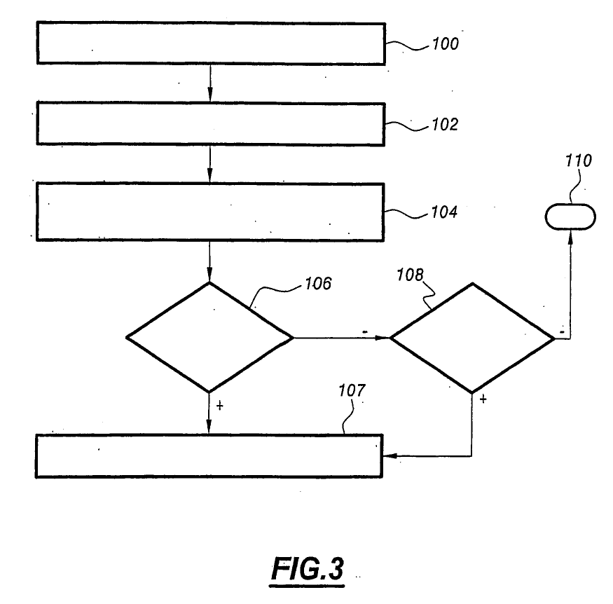

FIG. 3 is a diagram illustrating a resource management method according to the invention.

A resource management system 2 according to the invention is shown diagrammatically in FIG. 1. It includes a server type storage unit 4, a communications network 6, and a terminal 8.

The storage unit 4 has an interface 10 for communicating with the network 6, for example a TCP/IP interface (the TCP and IP communication protocols are standardized by the Internet Engineering Task Force (IETF)), and a database 12 containing a large number of computer files 14 in web language, referred to below as “web pages”.

The web pages 14 are designed by web page publishers offering services such as search engines, press services, websites selling music or films, for example. They are ordered by users of the terminals 8 and downloaded to the terminals 8 via the network 6.

As shown in FIG. 2, the web pages 14 include multimedia objects 15, 16, 17 and a declaration document 18 in web language.

The multimedia objects 15, 16, 17 include picture, audio, video, web page, application and executable software type objects. In this example of the use of the invention the web page 14 includes a video type object 15, an audio type object 16, and a Java application 17.

According to the W3C standards, the declaration document 18 is divided into three parts consisting of a root 19, a header 21 and a body 20.

The header 21 and the root 19 contain administrative data for the whole of the web page 14.

The body 20 contains a browser element 22 adapted to define the content of the web page 14, such as input fields, text content, data tables, for example in HTML or XHTML.

This browser element 22 enables display (restitution) of the web page 14 on the user's terminal 8 in the form of data (text, pictures, video) displayed on the screen, sound reproduced by the loudspeaker, dynamic modification of data already displayed on the screen, for example modification of the terminal battery level indicator, or action at an interface of the terminal, such as initiating a telephone call.

According to the invention, the body 20 further includes three browser elements 23, 24, 25 that declare the multimedia objects 15, 16 and 17 (these declaration elements 23, 24, 25 are separate from the declaration document 18). These elements 23, 24, 25 include parameters that characterize the multimedia objects 15, 16 and 17 and information on their location and identification in the form of web addresses known as URI (Universal Resource Identifier) addresses that point to the multimedia objects 15, 16, 17. The browser elements 22, 23, 24 and 25 are standardized by the World Wide Web Consortium (W3C), which is the standardization organization for the world wide web.

According to the invention, the body 20 further includes browser elements 26, 27, 28 that declare the resources needed to display the multimedia objects 15, 16, 17.

In the embodiment of the invention shown in FIG. 2, the element 26 declares the resources needed to display the video type object 15. The element 27 declares the resources needed to reproduce the audio type object 16. The element 28 declares the resources needed to execute the Java application 17.

These browser elements are defined by the web publisher who designed the web page 14.

Each browser element 26, 27 and 28 defines, between two tags, parameters that characterize the hardware and software resources needed for complete and optimized rendition of each multimedia object 15, 16, 17.

Each of these parameters can be associated with a tolerance value defining the degree to which degrading of the parameters is permissible. A default tolerance value can be predefined by the terminal 8.

The resources needed for complete and optimized rendition of the multimedia objects 15, 16, 17 include resources represented in the FIG. 1 diagram by the reference numbers 31, 32 and 33 that form part of the set of resources of the network 6 represented in the diagram by the reference number 29 and resources represented in the diagram by the reference numbers 34, 35 and 36 that form part of the set of resources of the terminal 8 represented in the diagram by the reference number 30. The nature of these resources is explained later in the description.

The communications network 6 is a general packet radio service (GPRS) type network, for example. It includes a network of servers forming the resources represented in the diagram by the reference number 29. The resources 29 of the network 6 are characterized by parameters such as bandwidth, delay, jitter, and loss rate.

The bandwidth is the quantity of data transmitted per unit time, for example 5000 bytes per second. The delay is the time to travel between two units connected to the network 6, for example between the storage unit 4 and the user's terminal 8. This time takes into account transit times through all intermediate units such as routers and switches, transmission times in cables, etc.

The jitter is the variation of the bandwidth as a function of time.

The loss rate represents the deterioration of the information transmitted. It is expressed as a percentage representing the ratio of the degraded information to the information as transmitted. It is equal to 0.01%, for example.

Other parameters can be added to the above parameters, for example a priority that enables units of the network 6 to give preference to processing certain multimedia objects over others.

For example, a body 20 including only the browser elements 23 and 26 can be formulated as follows:

```
<BODY>
<OBJECT data= “http://www.orange.com/image/orange.png”
  type = “image/png”>.
<RESOURCE bandwidth = “64000” delay= “0.130” memory=
  “3500”>
</RESOURCE>
</OBJECT>
</BODY>
```

In this example, the browser element 25 declares the image 15 and the browser element 26 declares the resources 31 and 34 needed for complete and optimized display of said image 15. Those resources include a bandwidth of 64000 bits, a delay of 130 milliseconds and a required memory space in the terminal 8 of 3500 bytes.

The user's terminal 8 includes an interface 39 for communicating with the network 6, for example a TCP/IP type interface, a man-machine interface 40, a microprocessor 44, a memory 46 for storing data, and a resource manager 47.

The man-machine interface 40 includes an input device such as a keyboard (voice control is an option), a loudspeaker, and a display device 41 such as a display screen.

For example, the memory 46 can be a non-volatile memory of ROM (Read Only Memory), EEPROM (Electrically Erasable Programmable Read Only Memory) or RAM (Random Access Memory) type or a flash memory card or the like.

The resource manager 47 manages the resources required by the modules or applications of the terminal 8. The resources within the manager 47 are represented in the diagram by the reference number 30. The resources required by the modules or applications of the terminal include in particular the resources of a microprocessor 44 (computation power) and of a memory 46 (available memory capacity). The manager 47 therefore always knows the available computation power and capacity of the microprocessor 44 and the available capacity of the memory 46.

The manager 47 can also request allocation of resources available on the network 6. To this end, it can consult the units of the network 6 via the communication interface 39.

Resource allocation requests going from the manager 47 to the units of the network 6 use the IETF's Resource reSerVation Protocol (RSVP), for example. The reference numbers 31, 34; 32, 35 and 33, 36 in the diagram represent the quantities of resources needed for complete and optimized rendition of the multimedia objects 15, 16 and 17, respectively.

The terminal 8 further includes a web browser 48, an application interface 50 for communication between the browser 48 and the manager 47, and an application interface 52 for communication between the browser 48 and the display device 41.

The web browser 48 can interpret the browser elements 22, 23, 24, 25, 26, 27, and 28 contained in the document 18 that declares the web page 14.

The web browser 48 can in particular interpret the browser elements 26, 27 and 28 relating to the resources needed to render (restitute) the multimedia objects 15, 16, 17.

To this end, it can request the manager 47 to allocate resources represented by the reference numbers 31, 34; 32, 35 and 33, 36 and declared by the browser elements 26, 27, and 28, respectively. Those resources include software and infrastructure hardware resources relating to the network 6 and to the terminal 8.

If the manager 47 cannot allocate the resources represented by the reference numbers 31, 34; 32, 35, and 33, 36 needed for undegraded (complete and optimized) rendition of the multimedia objects 15, 16 and 17 as intended by the publisher of the web page, the web browser 48 can generate a message and send it to the screen 41 via the interface 52. This message informs the user of the terminal 8 that the terminal is not able to display the requested web page 14 under conditions conforming to the optimum downloading conditions, and can offer display of the web page 14 in a degraded mode.

The degree to which display can be degraded is indicated in the declaration of the resource in the form of a tolerance for each parameter that has been assigned a value.

If the manager 47 can allocate the resources represented by the reference numbers 31, 34; 32, 35, and 33, 36 needed to display the multimedia objects 15, 16, 17, the web browser 48 can initiate downloading and rendition of those objects.

The interface 50 is an application programming interface (API) written in the W3C's Document Object Model (DOM) language, for example. It models the behavior of a physical interface of the terminal 8 so that a web page 14 using that interface operates on the physical interfaces associated with the terminal 8.

This DOM API type interface is independent of the user terminal and therefore portable to any type of terminal and even to any type of electronic data processing equipment.

As can be seen in FIG. 3, the method of managing the resources needed to display the web page 14 includes a step 100 of downloading the declaration document 18 from the storage unit 4 to the user's terminal 8 via the network 6.

In a step 102, the web browser 48 interprets the browser elements 22, 23, 24, 25, 26, 27 and 28 contained in the document 18 and in particular the browser elements 26, 27 and 28 that declare the resources represented by the reference numbers 31, 34; 32, 35, and 33, 36 that are needed for complete and optimized rendition of the video type object 15, the audio type object 16, and the Java application 17 as intended by the publisher of the web page. It then sends the resource manager 47 a request to allocate each of the resources represented by the reference numbers 31, 34; 32, 35 and 33, 36 and needed to render each multimedia object 15, 16 and 17.

In a step 106, the manager 47 requests the allocation of the resources represented by the reference numbers 31, 34; 32, 35 and 33, 36 that form part of the resources that are represented by the reference numbers 30 and 29 and are available in the terminal 8 and in the network 6, respectively.

When the resources represented by the reference numbers 31, 34; 32, 35, and 33, 36 and needed to render the objects 15, 16, and 17, respectively, have been allocated, the manager 47 informs the browser 48 of this and the browser initiates downloading and rendition of the objects 15, 16 and 17 in a step 107.

If the resources of the network or the terminal are insufficient compared to the resources represented by the reference numbers 31, 34; 32, 35, and 33, 36 required by the elements 26, 27, 28 of the web page 14, the manager 47 informs the web browser 48 of this in a step 108.

The browser 48 then sends the user of the terminal 8 via the display screen 41 an information message that includes a proposal to display the web page 14 in a degraded mode.

If the user of the terminal 8 declines to have the web page 14 displayed in a degraded mode, execution of the management method according to the invention ceases in an end step 110.

If the user accepts display of the web page in a degraded mode, execution of the method continues with the step 107.

In a different embodiment the terminal 8 is a terminal of any type, for example a server, a personal computer, a landline or mobile telephone, a consumer electronic device such as a television, an industrial facility such as a surveillance center, or a commercial unit such as an interactive terminal.

In another embodiment the interface 50 is a proprietary interface.

In a further embodiment the declaration document 18 includes one browser element declaring all the resources needed for all the multimedia objects 15, 16 and 17 and corresponding to the sum of the resources needed for each multimedia object.

In a further embodiment, a browser element 26 that declares resources needed to render multimedia objects is inserted in the header 21 of the declaration document 18. Under such circumstances, the resource(s) that are requested are those for all the multimedia objects.

For example, the header 21 of the document 18 can be formulated as follows:

<head>
<title> Example of the structure of a XHTML document
</title>
<link rel=“stylesheet” href=“style.css” type=“text/css”/>
<resource> bandwidth=“64000” delay=“0.125” memory= “9125”
</resource>
</head>

In this example the element declaring the resources 31, 32, 33, 34, 35, and 36 needed to render all the multimedia objects 15, 16, 17 of the web page 14 includes a bandwidth of 64000 bits, a delay of 125 milliseconds and a required memory space in the terminal 8 of 9125 bytes.

In a further embodiment an element that declares the resources needed is inserted in the root 19 of the declaration document 18 of the web page.

In a further embodiment the method according to the invention does not include a step of proposing to display the web page in a degraded mode and its execution ceases after sending the user a message indicating that it is not possible to display the web page completely.

In a further embodiment the resource manager 47 also manages the resources of the storage unit 4. Under such circumstances, the elements 26, 27 and 28 that declare resources can also contain resource information relating to the server 4 and needed for the complete and optimized rendition of the multimedia objects.

1. A terminal (8) for managing resources (29, 30, 31, 32, 33, 34, 35, 36) needed to display at least one web page (14) that consists of at least one multimedia object (15, 16, 17) and a declaration document (18) including at least one element (23, 24, 25) that declares the or each multimedia object (15, 16, 17), the declaration document (18) and the or each multimedia document (15, 16, 17) being downloaded to the terminal (8) from a storage unit (4) via a communications network (6) and said terminal (8) including a resource manager (47), a display device (41), and a web browser (48), which terminal is characterized in that said web browser (48) can interpret at least one element (26, 27, 28) that declares at least one resource (29, 30, 31, 32, 33, 34, 35, 36) needed to render the or each multimedia object (15, 16, 17), said element (26, 27, 28) that declares the or each resource can be included in the declaration document (18), and said web browser (48) can send the resource manager (47) a request to allocate the or each resource (29, 30, 31, 32, 33, 34, 35, 36) needed to render the or each multimedia object (15, 16, 17).

2. A terminal (8) according to claim 1, characterized in that the resource manager (47) can inform the web browser (48) of the availability of the or each resource (29, 30, 31, 32, 33, 34, 35, 36) and the web browser (48) can send a warning message to the display device (41) if the resource or resources (29, 30, 31, 32, 33, 34, 35, 36) needed to render the or each multimedia object (15, 16, 17) is or are not available and send a request to download the or each multimedia object (15, 16, 17) if the resource or resources (29, 30, 31, 32, 33, 34, 35, 36) is or are available.

3. A terminal (8) according to claim 1, characterized in that it includes an interface (50) for communication between the web browser (48) and said resource manager (47).

4. A terminal (8) according to claim 3, characterized in that the communication interface (50) is either a proprietary interface or a software interface written in the W3C DOM language.

5. A web page (14) structure consisting of at least one multimedia object (15, 16, 17) and a declaration document (18) that includes at least one element (26, 27, 28) that declares the or each multimedia object (15, 16, 17), said web page (14) being stored in a storage unit (4) and downloaded to a terminal (8) via a communications network (6), which web page structure is characterized in that the declaration document (18) contains at least one element (26, 27, 28) that declares at least one resource (29, 30, 31, 32, 33, 34, 35, 36) needed to render the or each multimedia object (15, 16, 17).

6. A web page (14) structure according to claim 5, characterized in that the declaration document (18) includes a body (20) and the or each element (26, 27, 28) that declares the or each resource (29, 30, 31, 32, 33, 34, 35, 36) is included in said body (20) of the declaration document (18) and applies either to a single multimedia object (15, 16, 17) or to all the multimedia objects (15, 16, 17) of the web page (14).

7. A web page (14) structure according to claim 5, characterized in that the declaration document (18) includes a header (21) and the or each element (26, 27, 28) that declares the or each resource (29, 30, 31, 32, 33, 34, 35, 36) is included in that header (21) and applies to all the multimedia objects (15, 16, 17) of the web page (14).

8. A web page (14) structure according to claim 5, characterized in that the declaration document (18) includes a root (19) and the or each element (26, 27, 28) that declares the or each resource (29, 30, 31, 32, 33, 34, 35, 36) is included in that root (19) and applies to all the multimedia objects (15, 16, 17) of the web page (14).

9. A web page (14) structure according to claim 5, characterized in that the or each element (26, 27, 28) that declares the or each resource (29, 30, 31, 32, 33, 34, 35, 36) includes at least one parameter that characterizes resources of the network (6) selected from the group comprising a bandwidth, a delay, a jitter, a loss rate, or a priority and/or at least one parameter that characterizes resources of the terminal (8) selected from the group comprising an available capacity of a microprocessor (44), an available capacity of a memory (46), and characteristics of a display device (41).

10. A method of managing resources (29, 30, 31, 32, 33, 34, 35, 36) needed to display at least one web page (14) that consists of at least one multimedia object (15, 16, 17) and a declaration document (18) that includes at least one element (23, 24, 25) that declares the or each multimedia object (15, 16, 17), wherein said web page (14) is downloaded from a storage unit (4) to a terminal (8) via a communications network (6), the terminal (8) includes a resource manager (47), a web browser (48), and a display device (41), and said method comprises the following steps:
downloading (100) the declaration document (18) from the storage unit (4) to the terminal (8), said declaration document (18) including at least one element (26, 27, 28) that declares at least one resource (29, 30, 31, 32, 33, 34, 35, 36) needed to render the or each multimedia object (15, 16, 17);
the web browser (48) interpreting (102) the or each element (26, 27, 28) that declares the or each resource (29, 30, 31, 32, 33, 34, 35, 36) and sending (104) the resource manager (47) a request to allocate the or each resource (29, 30, 31, 32, 33, 34, 35, 36) needed to render the or each multimedia object (15, 16, 17);
the resource manager (47) requesting (106) allocation of the available resource or resources (29, 30, 31, 32, 33, 34, 35, 36) of the network (6) and/or the terminal (8) and/or the storage unit (4);
the web browser (48) sending (108) the display device (41) a warning message if the resource or resources (29, 30, 31, 32, 33, 34, 35, 36) needed to render the or each multimedia object (15, 16, 17) is or are not available; and
the web browser (48) initiating (107) downloading of the or each multimedia object (15, 16, 17) if the resource or resources (29, 30, 31, 32, 33, 34, 35, 36) needed to render the or each multimedia object (15, 16, 17) is or are available.

11. A system (2) for managing resources (29, 30, 31, 32, 33, 34, 35, 36) needed to display at least one web page (14) consisting of at least one multimedia object (15, 16, 17) and a declaration document (18) that includes at least one element (23, 24, 25) that declares the or each multimedia object (15, 16, 17), said system (2) comprising a unit (4) for storing the or each web page (14), a communications network (6), and a terminal (8) adapted to download the or each web page (14) from the storage unit (4) via the telecommunications network (6), which system is characterized in that it includes a terminal (8) according to claim 1.

12. A terminal (8) according to claim 2, characterized in that it includes an interface (50) for communication between the web browser (48) and said resource manager (47).

13. A web page (14) structure according to claim 6, characterized in that the or each element (26, 27, 28) that declares the or each resource (29, 30, 31, 32, 33, 34, 35, 36) includes at least one parameter that characterizes resources of the network (6) selected from the group comprising a bandwidth, a delay, a jitter, a loss rate, or a priority and/or at least one parameter that characterizes resources of the terminal (8) selected from the group comprising an available capacity of a microprocessor (44), an available capacity of a memory (46), and characteristics of a display device (41).

14. A web page (14) structure according to claim 7, characterized in that the or each element (26, 27, 28) that declares the or each resource (29, 30, 31, 32, 33, 34, 35, 36) includes at least one parameter that characterizes resources of the network (6) selected from the group comprising a bandwidth, a delay, a jitter, a loss rate, or a priority and/or at least one parameter that characterizes resources of the terminal (8) selected from the group comprising an available capacity of a microprocessor (44), an available capacity of a memory (46), and characteristics of a display device (41).

15. A web page (14) structure according to claim 8, characterized in that the or each element (26, 27, 28) that declares the or each resource (29, 30, 31, 32, 33, 34, 35, 36) includes at least one parameter that characterizes resources of the network (6) selected from the group comprising a bandwidth, a delay, a jitter, a loss rate, or a priority and/or at least one parameter that characterizes resources of the terminal (8) selected from the group comprising an available capacity of a microprocessor (44), an available capacity of a memory (46), and characteristics of a display device (41).

16. A system (2) for managing resources (29, 30, 31, 32, 33, 34, 35, 36) needed to display at least one web page (14) consisting of at least one multimedia object (15, 16, 17) and a declaration document (18) that includes at least one element (23, 24, 25) that declares the or each multimedia object (15, 16, 17), said system (2) comprising a unit (4) for storing the or each web page (14), a communications network (6), and a terminal (8) adapted to download the or each web page (14) from the storage unit (4) via the telecommunications network (6), which system is characterized in that it includes a terminal (8) according to claim 2.

17. A system (2) for managing resources (29, 30, 31, 32, 33, 34, 35, 36) needed to display at least one web page (14) consisting of at least one multimedia object (15, 16, 17) and a declaration document (18) that includes at least one element (23, 24, 25) that declares the or each multimedia object (15, 16, 17), said system (2) comprising a unit (4) for storing the or each web page (14), a communications network (6), and a terminal (8) adapted to download the or each web page (14) from the storage unit (4) via the telecommunications network (6), which system is characterized in that it includes a terminal (8) according to claim 3.

18. A system (2) for managing resources (29, 30, 31, 32, 33, 34, 35, 36) needed to display at least one web page (14) consisting of at least one multimedia object (15, 16, 17) and a declaration document (18) that includes at least one element (23, 24, 25) that declares the or each multimedia object (15, 16, 17), said system (2) comprising a unit (4) for storing the or each web page (14), a communications network (6), and a terminal (8) adapted to download the or each web page (14) from the storage unit (4) via the telecommunications network (6), which system is characterized in that it includes a terminal (8) according to claim 4.
